(19) United States
(12) Patent Application Publication
(10) Pub. No.: US 2025/0342188 A1
(43) Pub. Date: Nov. 6, 2025

(54) INFORMATION RETRIEVAL IN MACHINE LEARNING QUESTION ANSWERING SYSTEMS

(71) Applicants: Ali Reza Vahdat, Toronto (CA); Ashkan Alinejad, Toronto (CA)

(72) Inventors: Ali Reza Vahdat, Toronto (CA); Ashkan Alinejad, Toronto (CA)

(21) Appl. No.: 19/196,284

(22) Filed: May 1, 2025

Related U.S. Application Data
(60) Provisional application No. 63/641,324, filed on May 1, 2024.

(51) Int. Cl. G06F 16/3329; G06F 16/334; G06F 40/30

(52) U.S. Cl. CPC G06F 16/33295; G06F 16/3344; G06F 40/30

(57) ABSTRACT

Evaluating and improving information retrieval in question-answering systems is an area of importance in machine learning growth. Retrieval components in a retrieval-augmented generation (RAG) question answering system enable machine learning models to provide more accurate and reliable answers to questions. Systems for retriever evaluation involve processing queries in comparison to reference documents. The system first retrieves documents deemed relevant, then generates a first answer based on them. A second answer is generated using a set of documents that includes ground truth documents known to be relevant to the query. By analyzing semantic overlap between these responses, a quantitative evaluation of the retrieval component is obtained. This evaluation then informs automatic modifications to retrieval parameters, enhancing future document selection and response accuracy.

### CROSS-REFERENCE TO RELATED APPLICATIONS

The present application claims the benefit of priority from U.S. Provisional Application No. 63/641,324 filed May 1, 2024, and entitled “EVALUATING THE RETRIEVAL COMPONENT IN LLM-BASED QUESTION ANSWERING SYSTEMS,” the disclosure of which is incorporated by reference herein in its entirety.

### TECHNICAL FIELD

The present application is generally directed to machine learning systems, and more particularly to systems and methods for automatically evaluating and improving retrieval components of retrieval augmented generation systems.

### BACKGROUND

Question Answering (QA) systems are computer systems that attempt to provide an accurate response to a natural language query from the user, based on relevant contexts from a provided pool of knowledge. QA systems use machine learning models such as large language models (LLMs) to identify and generate answers to questions input to them. To enhance the accuracy of QA systems and mitigate the risk of hallucinations from LLMs, Retrieval-Augmented Generation (RAG) methods have been developed, in which generative machine learning models are provided with additional documents containing the answer to a query and are trained to generate answers to input questions using the additional documents. RAG systems integrate a retriever component, which retrieves relevant document chunks to provide the LLM with the necessary context for generating responses. Retriever components that can effectively identify relevant data in answer to a query (and also filter out irrelevant data) are a key component of QA systems, as they enable accurate responses to be generated by the systems.

Developers of RAG QA systems have historically had difficulty evaluating the performance of retriever components at retrieving relevant documents or chunks of documents. Evaluation of the retriever component typically relies on two types of metrics: (a) Rank-agnostic metrics, such as Precision and Recall, which compare retrieved chunks with gold-labeled chunks, and (b) Rank-aware metrics, such as Normalized Discounted Cumulative Gain (NDCG) or Mean Reciprocal Rank (MRR), which consider the order of retrieved documents. Both of these typical methods of evaluating retriever components fall short of generating insights into improving the retriever component within the QA system as a whole. Further, both methods of evaluating retriever components are prone to error and may not produce a fully accurate representation of the performance of the retriever component. For example, typical metrics for evaluating retriever components tend to focus solely on the retriever components themselves and do not analyze their performance within the RAG QA system as a whole. As another example, the typical methods of evaluating retrievers tend to focus only on the effects of a retriever when compared with annotated data, which can significantly impact the ability to accurately assess retriever behavior, particularly when annotators fail to annotate all documents containing the answer. As such, there is a need for more effective methods for evaluating and improving retriever components of question answering systems.

### SUMMARY

Systems and methods are provided herein for evaluating and improving retriever components of RAG question answering systems using machine learning models. RAG question answering systems as disclosed herein are configured to receive a question, retrieve documents related to the question using a retrieval component, and using a machine learning model such as an LLM to generate a first answer to the question based on the documents retrieved by the retrieval component. To evaluate the performance of the retrieval component as it functions with the entire system, a second answer is generated by the machine learning model based on a ground truth document, or a document known to contain the answer to the question. Then the system uses a comparison model to compare the first answer and the second answer. Based on the results of the comparison, the retrieval component may be evaluated and refined.

The systems and methods described herein provide for numerous benefits. For example, improving information retrieval components provides for greater quality assurance that the answers generated by a RAG question answering system are accurate and correct. Moreover, the systems and methods described herein provide for technical improvements over conventional generative artificial intelligence or machine learning systems and methods for evaluating Retrieval systems. Prior systems for evaluating retrieval components in RAG question answering tend to focus solely on the retriever components themselves and do not analyze their performance within the RAG QA system as a whole. The solutions described herein enable greater contextual understanding of both the retriever system and its connection to other elements of the RAG system.

In an aspect of the present disclosure, a computer-implemented method for evaluating and improving a retrieval component in a retrieval augmented generation system is disclosed. The computer-implemented method may include receiving, by one or more processors, a query through an input device and a set of documents from a data source. The computer-implemented method may further include providing, by the one or more processors, the query, and the set of documents to a retrieval component of a retrieval augmented generation system. The computer-implemented method may further include filtering, by the retrieval component, a first subset of documents relevant to the query from the set of documents, based on semantic similarity between the query and content of the documents. The computer-implemented method may further include generating, by a first language model, a first answer to the query based on the filtered first subset of documents. The computer-implemented method may further include providing, by the one or more processors, the query and a second subset of documents from the set of documents to a second language model, the second subset of documents comprising at least one ground truth document corresponding to the query. The computer-implemented method may further include generating, by the second language model, a second answer to the query based on the second subset of documents. The computer-implemented method may further include determining, by a comparison model, a first overlap score between the first answer and the second answer, wherein the comparison model is configured to identify semantic similarities between the first answer and the second answer; and refining, by the one or more processors, the retrieval component by adjusting parameters of the retrieval component based on the first overlap score between the first answer and the second answer.

In an additional aspect of the present disclosure, a computer-implemented method is provided for evaluating and improving information retrieval in a question-answering system. The method includes receiving, by one or more processors, a query and a collection of reference documents. The method also includes using a retrieval component to identify a first set of documents from the collection that are determined to be relevant to the query. The method also includes generating a first response to the query using a language model that processes information from the first set of documents. The method also includes generating a second response to the query using the language model that processes information from a second set of documents containing at least one ground truth document known to be relevant to the query. The method also includes computing a quantitative evaluation of the retrieval component by analyzing semantic overlap between the first response and the second response; and automatically modifying operational parameters of the retrieval component based on the quantitative evaluation to improve future document retrieval operations.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of a retrieval augmented generation (RAG) question answering system in accordance with aspects of the present disclosure.

FIG. 2 is a block diagram illustrating example structural aspects of a RAG question answering system in accordance with aspects of the present disclosure.

FIG. 3 illustrates an example dataflow for evaluating information retrieval in a RAG question answering system in accordance with aspects of the present disclosure.

FIG. 4 is a flow diagram of an exemplary method for evaluating and improving a retrieval component in a retrieval augmented generation system in accordance with aspects of the present disclosure.

FIG. 5 is a flow diagram of an exemplary method for evaluating and improving information retrieval in a question-answering system in accordance with aspects of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses, or which render other details difficult to perceive may have been omitted. Like numbers in the figures refer to the same components and/or processes. It should be understood, of course, that this disclosure is not limited to the particular embodiments illustrated herein.

### DETAILED DESCRIPTION

The present disclosure relates to systems and methods for evaluating and improving retrieval components in machine learning question answering systems. More specifically, the disclosure provides techniques for automatically evaluating and refining retrieval components of Retrieval Augmented Generation (RAG) systems by comparing answers generated using retrieved documents against answers generated using ground truth documents.

RAG question answering systems typically include a retrieval component that identifies relevant documents from a corpus and a generation component, often implemented as a large language model (LLM), that produces answers based on the retrieved documents. The retrieval component serves as a critical element in such systems, as it determines which documents provide context for the generation component. Conventional evaluation approaches for retrieval components often assess performance using metrics such as Precision, Recall, Normalized Discounted Cumulative Gain (NDCG), or Mean Reciprocal Rank (MRR), which compare retrieved documents against annotated ground truth documents.

The systems and methods disclosed herein improve upon conventional approaches by evaluating retrieval components within the context of the entire RAG system. Rather than focusing solely on how well a retrieval component identifies annotated documents, the disclosed systems evaluate how effectively retrieved documents enable a language model to generate accurate answers. This holistic approach may address limitations of conventional evaluation techniques, including cases where relevant documents exist but have not been annotated, or where irrelevant documents retrieved alongside relevant ones may mislead the generation component.

In various implementations, RAG systems may receive a query and a collection of documents, use a retrieval component to identify potentially relevant documents, and generate a first answer using these retrieved documents. The systems may then generate a second answer using one or more ground truth documents known to contain information relevant to the query. By comparing these two answers using a comparison model configured to identify semantic similarities, the systems can quantitatively evaluate the retrieval component's performance. Based on this evaluation, operational parameters of the retrieval component may be automatically modified to improve future document retrieval operations.

The comparison model may be implemented using various techniques, including LLM-based comparison, token-based metrics such as ROUGE-1 or BLEU, or embedding-based metrics like BERTScore. In some implementations, the comparison model may generate binary judgments (e.g., “pass” or “fail”) indicating whether the retrieved documents enabled the generation of an answer semantically similar to the ground truth answer. More granular evaluation scales may be employed for specialized domains where nuances in answers are particularly important.

Particular implementations of the subject matter described in this disclosure may be implemented to realize one or more of the following potential advantages or benefits. In some aspects, the present disclosure provides techniques for evaluating retrieval components that account for their performance within the complete RAG system rather than in isolation. By comparing answers generated using retrieved documents against answers generated using ground truth documents, the systems may detect when retrieved documents enable correct answers even when those documents differ from annotated ground truth documents. This approach may overcome limitations of conventional retrieval evaluation metrics that penalize retrievers for not identifying specific annotated documents, even when other retrieved documents contain the same factual information.

The systems and methods may provide enhanced precision in identifying problematic retrieval scenarios that conventional metrics might miss. For example, when a retrieval component returns both relevant documents and misleading documents, conventional metrics may indicate successful retrieval based on the presence of ground truth documents. However, the approach described herein may detect cases where misleading documents cause the generation component to produce incorrect answers despite having access to relevant information. By identifying such scenarios, the systems enable targeted refinement of retrieval parameters to specifically address these challenges.

The automated refinement capabilities described in the disclosure may reduce the need for extensive manual annotation and evaluation of retrieval components. Traditional retrieval evaluation often requires comprehensive labeling of relevant documents for each query, which can be prohibitively expensive and time-consuming for large document collections. The disclosed systems may function effectively with fewer annotated documents by focusing on answer quality rather than document-level matching, potentially enabling more efficient development and improvement of RAG systems across various domains and applications.

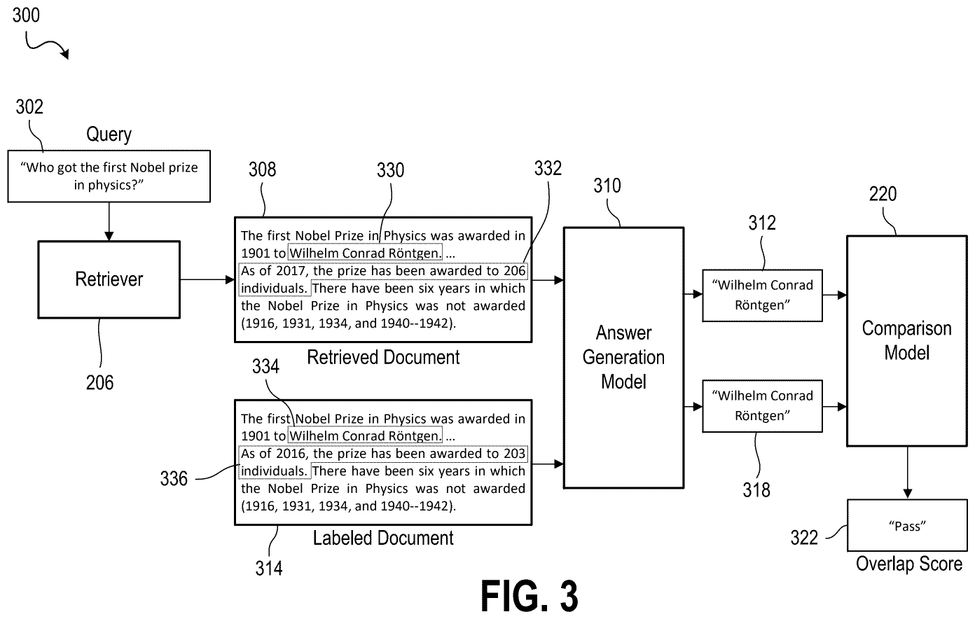

The systems and methods may adapt to the natural evolution of document collections over time. As illustrated in FIG. 3, the approach can correctly evaluate retrieval performance even when retrieved documents contain updated information (e.g., statistics from 2017) compared to ground truth documents (e.g., statistics from 2016), provided that both documents contain the core information needed to answer the query. This adaptability may be particularly valuable for maintaining RAG system performance when working with dynamic document collections that receive regular updates or revisions.

In specialized domains such as legal or medical question answering, disclosed implementations may be configured with more granular evaluation scales to account for the critical importance of nuance and precision in generated answers. By tailoring the comparison model to domain-specific requirements, the systems may provide more meaningful evaluations of retrieval performance in contexts where small variations in answers could have significant implications. This customization capability may enable the development of more reliable domain-specific RAG systems that meet the strict accuracy requirements of professional applications.

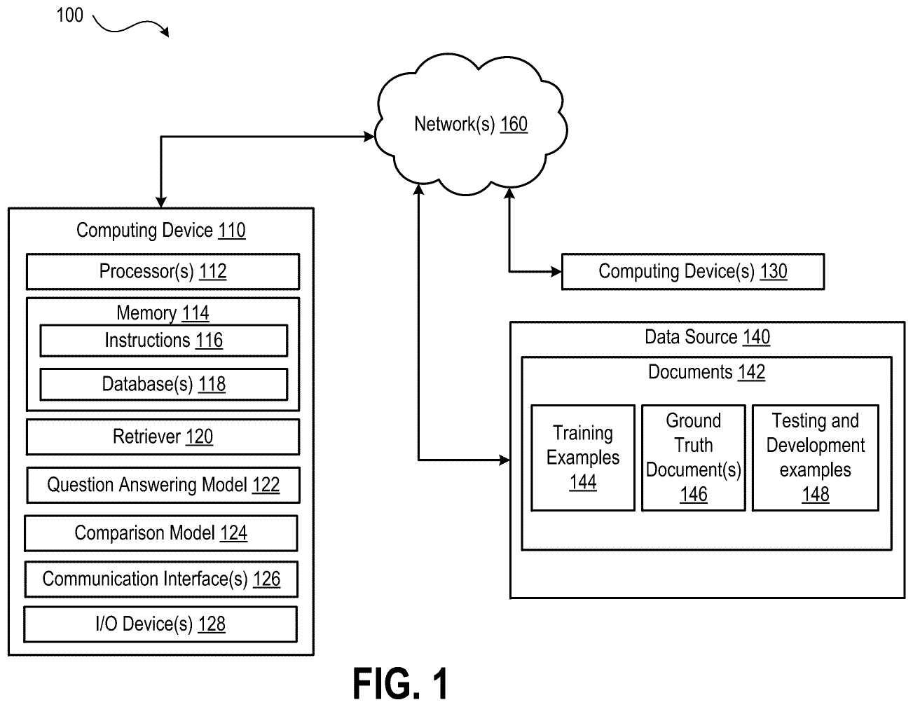

In FIG. 1, a block diagram of a question answering system in accordance with aspects of the present disclosure is shown as a system 100. The system 100 may be configured as a retrieval augmented generation (RAG) question answering system. In some configurations, the system 100 may be capable of receiving a query (e.g., a question) from an input device, retrieving information and documents from one or more data sources relevant to the query using a retriever, and generating an answer to the query based on the documents retrieved. A retriever, also referred to as a retriever component, a retrieval component, or a retrieval system, identifies documents and information that are relevant to the query based on semantic information from the query. System 100 may include components and models that may provide improved evaluation and automatic refinement of a retriever component to improve both accuracy and precision in information retrieval. Exemplary details regarding the above-identified functionality of the system 100 are described in greater detail below.

As illustrated in FIG. 1, the system 100 includes a computing device 110 that includes one or more processors 112, a memory 114, a retriever 120 (alternatively described herein as a retrieval system, a retriever component, or a retrieval component), a question answering model 122, a comparison model 124, one or more communication interfaces 126, and input/output (I/O) devices 128. The one or more processors 112 may include a central processing unit (CPU), graphics processing unit (GPU), a microprocessor, a controller, a microcontroller, a plurality of microprocessors, an application-specific integrated circuit (ASIC), an application-specific standard product (ASSP), or any combination thereof. The memory 114 may comprise read only memory (ROM) devices, random access memory (RAM) devices, one or more hard disk drives (HDDs), flash memory devices, solid state drives (SSDs), other devices configured to store data in a persistent or non-persistent state, network memory, cloud memory, local memory, or a combination of different memory devices. The memory 114 may store instructions 116 that, when executed by the one or more processors 112, cause the one or more processors 112 to perform operations described herein with respect to the functionality of the computing device 110 and the system 100. The memory 114 may further include one or more databases 118, which may store data associated with operations described herein with respect to the functionality of the computing device 110 and the system 100.

The communication interface(s) 126 may be configured to communicatively couple the computing device 110 to the one or more networks 160 via wired and/or wireless communication links according to one or more communication protocols or standards. The I/O devices 128 may include one or more display devices, a keyboard, a stylus, a scanner, one or more touchscreens, a mouse, a trackpad, a camera, one or more speakers, haptic feedback devices, or other types of devices that enable a user to receive information from or provide information to the computing device 110.

The one or more databases 118 may include one or more document databases for storing documents. Non-limiting examples of documents that may be stored in a document database of the databases 118 include webpages (e.g., HTML documents), text documents, news articles, legal documents (e.g., case law documents, statutes, legal briefs, court filings and so on), software code, or other documents that may be retrieved as part of answering a question input to the system in a query. Additionally or alternatively, documents, metadata, and/or other information may be stored on and/or retrieved to the computing device 110 from other devices such as, for example, computing device(s) 130 or from a data source and/or a plurality of data sources, such as data source 140. Such devices and/or data sources may be communicatively coupled with the computing device 110 through the one or more networks 160.

Data source 140 may include a non-transitory computer-readable medium configured to store and retrieve data. The data source 140 may include one or more document databases for storing or accessing documents, e.g., documents 142. Non-limiting examples of documents that may be stored in a document database of the data source 140 include webpages (e.g., HTML documents), text documents, news articles, legal documents (e.g., case law documents, statutes, legal briefs, court filings and so on), software code, or other documents that may be retrieved as part of answering a question input to the system in a query. Documents 142 may include documents and/or datasets for training, testing, validating, or refining one or more of the machine learning models described herein. For example, documents 142 may include training example documents 144, ground truth documents 146, and testing and development example documents 148.

One example dataset of documents that may be used for the kind of evaluation of retriever components as described herein is the Natural Questions (NQ) corpus, as described by

Kwiatkowski, et al. in “Natural Questions: A Benchmark for Question Answering Research,” Transactions of the Association of Computational Linguistics (2019), the contents of which are incorporated by reference in their entirety. The NQ corpus includes 307K training examples, with an additional 8K examples allocated for development and a further 8K examples reserved for testing. Each sample in the dataset includes a single question, a tokenized representation of the question, a Wikipedia URL, and the HTML representation of the corresponding Wikipedia page. While the NQ corpus provides a useful dataset through which the system 100 and particularly the retriever 120 may be developed and tested, the NQ corpus is only described here as an example of the kind of set of documents to which the systems described herein may be applied. Those of ordinary skill in the art should readily recognize that other datasets may be applied for training, testing, or operating the system 100 and its respective models.

The documents 142 may include annotations, labels, indexes, or other data or metadata that may facilitate the retrieval of such documents as part of a retrieval augmented generation (RAG) question answering system. The documents described here are for illustrative purposes, and alternative configurations could be implemented without departing from the spirit and scope of this disclosure. In some configurations, there may be some overlap between one or more of the documents of the training example documents 144, the ground truth documents 146, and the testing and development example documents 148. For example, the training example documents may also contain one or more ground truth documents. In the example of the NQ corpus, the Wikipedia page HTML file associated with a question may be used as a ground truth document for the respective question. In some configurations, whether a document is included in one or more categories of documents or sets of documents may correspond to how the document is indexed or labeled within the dataset or within the metadata associated with a particular question within the dataset.

Computing device 110 may include a retriever 120. Retriever 120 may be configured to retrieve documents from a set of documents relevant to answering a query. For example, retriever 120 may receive a collection of documents from one or more databases 118 or from data source 140 over the network 160. Retriever 120 may identify documents relevant to a query input to the system by a user through one or more of the I/O devices 128. For example, retriever 120 may include functionality to perform natural language processing or tokenization of the query to identify terms of semantic similarity to the query in the documents. Alternatively, the retriever 120 may be configured to receive a preprocessed query or a tokenized query and use that to identify documents in the set of documents relevant to the query. In the example of the NQ corpus, a query and its associated documents include a tokenized representation of the question. Retriever 120 may receive a large collection of documents and process at least a portion of them to identify a subset of the documents that is relevant to the query.

In some configurations, the retriever 120 may be configured to filter a first subset of documents relevant to the query from the set of documents, based on semantic similarity between the query and content of the documents. An example technique by which this may be done is by using dense retrieval. Dense retrieval is a text retrieval method that conducts text retrieval in an embeddings space. Dense retrieval can be used to obtain relevant context or world knowledge in open-domain NLP tasks. In some configurations, queries and/or document chunks may be embedded using an embeddings model, such as, for example, the “E5-large-v2” model described by Wang, et al. in “Text Embeddings by Weakly-Supervised Contrastive Pre-training,” arXiv preprint, arXiv: 2212.03533 (2022), the contents of which are incorporated in their entirety by reference. Retriever 120 may identify documents relevant to the query based on the embeddings, such as by computing a similarity metric for the documents from the query. For example, in some configurations, documents may be evaluated for similarity to the query based on the cosine similarity of the embeddings of the query and the chunks. In some configurations,, Dense Passage Retrieval (DPR) may be used to retrieve a filtered subset of documents from the set of documents by encoding the query and documents. The distance between the embeddings of the query and each document may be used to select the filtered subset of documents. In some configurations, the top five documents based on embeddings or the similarity metrics may be identified by the retriever 120, although more or less than five documents may be retrieved depending on the level of detail that is desired in evaluating the retriever 120 and how many different documents the question answering model 122 may receive as inputs without negatively impacting the ability of question answering model 122 to accurately extract and generate answers based on the several documents.

Computing device 110 may include a question answering model 122. Question answering model 122 may be configured to receive as inputs the query and the filtered subset of documents retrieved by the retriever 120. Question answering model 122 may be configured to generate an answer to the query based on information extracted from the retrieved documents. In some configurations, question answering model 122 may be configured to provide a short answer. For example, the answer may be formed of 5-10 tokens or fewer, although other numbers of tokens may be used. A short answer may prove more easily comparable for systems designed to evaluate the performance of retrieval components (e.g., comparison model 124). A short answer may also prove less susceptible to variation in outputs that could cloud otherwise comparable results.

Question answering model 122 may be a trained machine learning model, such as a large language model (LLM) or another machine learning model trained to receive natural language inputs and generate natural language outputs. The question answering model 122 may be specifically trained to generate answers in response to a query based on documents. For example, the question answering model 122 may be trained on a dataset specifically including questions and answers, along with source documents containing the answers within their content. Input documents provided with the query may be retrieved by retriever 120, or may be provided separately from retriever 120. Additionally or alternatively, the question answering model 122 may be implemented using a commercially available large language model (or an “out of the box” LLM), such as OpenAI's GPT-3.5, GPT-4 and ChatGPT-Turbo, Anthropic's Claude, Google Gemini, Microsoft Copilot, Meta's LLaMA, or another similar large language model.

The question answering model 122 may also be configured to separately receive the query in connection with one or more annotated ground truth documents known to contain the answer to the query. Using the ground truth document, the question answering model 122 may generate an answer to the query using the ground truth document. Answers determined based on ground truth documents can enable comparisons with the answer generated by the question answering model 122 using the retriever-identified documents as a means for evaluating the performance of the retriever 120. The question answering model 122 may be configured to receive the query and ground truth document as a separate and independent input from input of a filtered subset of documents from the retriever 120. Separate prompts entered at separate times may be sufficiently independent from one another to allow for independent comparisons of the answers received. Alternatively, the question answering model 122 may be implemented as multiple distinct models or independent instances of the same kind of model. If implemented in multiple models, the question answering models may be configured using the same structure and the same parameters. Whether implemented as a single model with separate inputs or multiple models, it is important to have independent generation of answers and the same structure and parameters for each input. This makes it more likely that that any variation between the answers generated could be reasonably attributed to variations in the documents retrieved by the retriever 120, and not to variations in parameters or lingering influence from previous inputs. In this way, the variables of the model can be controlled and the system can be configured as an effective evaluation tool for the retriever 120.

Parameters for configuring the question answering model 122 may include weights applied to different data types or portions of a document. Alternatively or additionally, parameters for configuring question answering model 122 may include the wording of a prompt provided to the question answering model along with the document and the query. For example, the prompt could read similarly to the prompt of example (1) below. The portions of the prompt in example (1) in curly braces indicate portions that the system may automatically populate. For example, the {question} sections may be provided using the query or a tokenized version of the query, and the {context} section may include documents or portions of documents, either identified by the retriever 120 or provided in some other way (e.g., as a ground truth document for the query). Providing such a prompt or a similar input to the question answering model 122 may cause it to generate an answer to the question of the query.

(1) Please read the question provided below and then review the accompanying document excerpts. Your task is to answer the question using the information from the documents:
Question: {question}
Relevant Document chunks:
{context}
After considering the information in the documents, please provide an answer (maximum 5 tokens) to the question: {question}.
Answer:

Computing device 110 may include a comparison model 124. The comparison model 124 may be configured to evaluate the performance of the retriever 120 within the context of the whole QA system 100, by comparing a first answer generated by the question answering model 122 using documents retrieved by retriever 120 with a second answer generated by the question answering model 122 using one or more ground truth documents related to the query. Comparison model 124 may be configured to receive the first answer and the second answer as inputs. Based on the operations of comparison model 124, the comparison model may determine an overlap score between the first answer and the second answer. The overlap score may indicate the acceptability of the first answer generated by the QA model 122. Such acceptability may be correlated to the performance of the retriever 120, and may be used to refine or adjust parameters of the retriever 120 to improve information retrieval done by the retriever 120 in future operations of the system 100.

Comparison model 124 may be configured as a large language model (LLM). LLM-based comparison and evaluation models may be able to capture semantics of answers while attending to their nuanced variances. Comparison model 124 may be configured using one or more variable parameters. For example, comparison model 124 may be configured using similar parameters to the question answering model 122, or it may be configured using parameters more closely related to performing comparisons between answers.

In some implementations, one or more parameters of the comparison model 124 may be configured using a prompt like the following prompt of example (2) below. The portions of the prompt in example (2) in curly braces indicate portions that the system may automatically populate. For example, the {query} portion may be the query or a tokenized version of the query. The {answer} portion may be the second answer generated by the question answering model 122 using one or more ground truth documents related to the query. The {result} portion may be the first answer generated by the question answering model 122 using documents retrieved by retriever 120.

(2) You are CompareGPT, a machine to verify the correctness of predictions. Answer with only “Yes” or “No”.
You are given a question, one or more corresponding ground-truth answers, and a prediction from a model. Compare the “Ground-truth_answers” and the “Prediction” to determine whether the prediction correctly answers the question based on any of the provided ground-truth answers.
All information in at least one of the ground-truth answers must be present in the prediction, including numbers and dates. You must answer “No” if the prediction does not completely match at least one set of specific details in the ground-truth answers. There should be no contradicting statements in the prediction. The prediction may contain extra information that does not contradict the ground-truth answers.
Question: {query}
Ground-truth answers: {answer}
Prediction: {result}
Answer “Yes” if the prediction correctly answers the question based on any of the Ground-truth answers, otherwise answer “No”.

In the LLM-based comparison model 124 described above with respect to example (2), the yes or no output is an example of an overlap score between the first answer and the second answer. It is important to note that a yes/no overlap score (or a “pass”/“fail” or other binary system for) may be preferable for questions and relatively simple or succinct answers. The kind of grading system used by the comparison model 124 may be based on the characteristics of the dataset. For example, in the NQ-open dataset, questions are typically broad and the answers are typically short (e.g., fewer than five tokens). However, when evaluating QA tasks in specialized domains such as legal or medical domains, where nuances in the answers are crucial, a more granular grading scale is recommended.

While comparison model 124 has thus far been described herein as an LLM-based comparison model, other kinds of comparison models may be used to automatically compare answers generated by the QA model 122. For example, an Exact Match (EM) model may compare strings directly to determine whether they are exactly equal. An EM model may be overly strict for most evaluation applications, given the potential variability of outputs from the LLM of the QA model 122, but may be advantageous for queries for which exact string matching is important. For example, exact string matching may be important when high precision answers are required.

Another example of metrics that may function effectively in the comparison model 124 are token-based metrics such as ROUGE-1, BLEU, or METEOR. Token-based metrics may quantify the deviation between texts on a token or word level. Setting a threshold on token-based metrics may enable acceptance of answers that are highly similar but not exact matches.

Another example of metrics that may function effectively in the comparison model 124 are Embedding-based metrics. Embedding-based metrics may vectorize the answers and compute a similarity between the vectors. For example, the cosine similarity between the vectors may be calculated. BERTScore is an example of such a metric that is based on pretrained BERT embeddings which can capture the contextual information in answers. Comparison model 124 may include one or more of these alternative models, separately or in combination with one another or with an LLM-based comparison model. Those of skill in the art should recognize that other comparison models may be used.

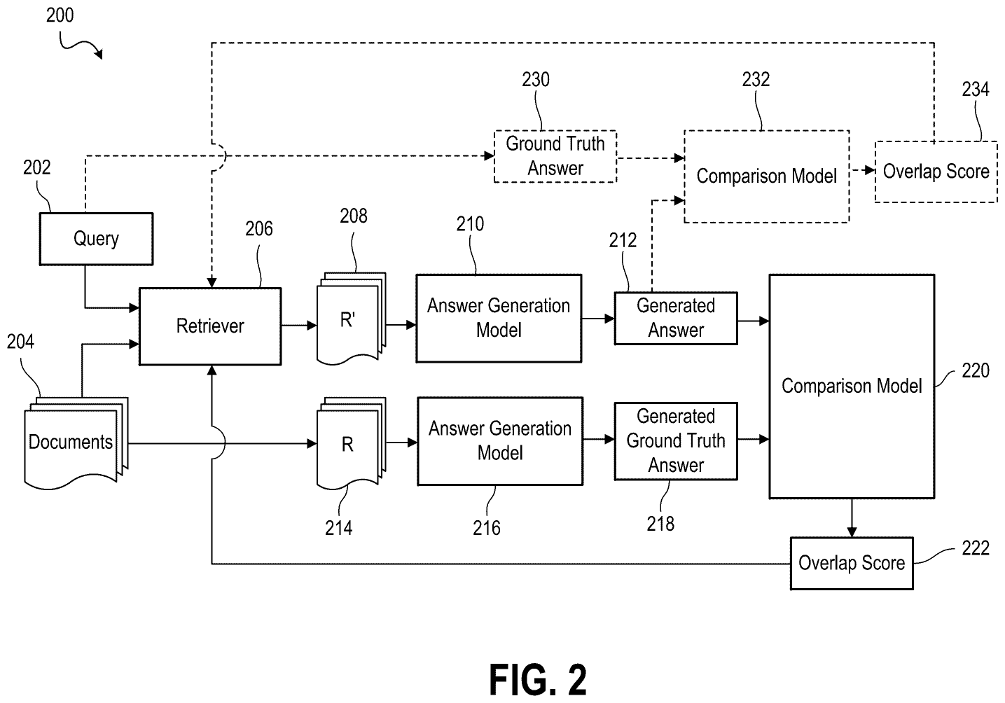

Reference is now made to FIG. 2, in which a block diagram illustrating example structural aspects of a RAG question answering system in accordance with aspects of the present disclosure is shown as system 200. System 200 illustrates an example architecture for a RAG question answering system, including an example data flow that the system 200 may apply to evaluate and improve the performance of a retriever component (e.g., retriever 120). System 200 may include, correspond, or be included in the system 100 of FIG. 1. Like the functionality discussed with respect to the components of system 100, system 200 may be configured to evaluate and improve the performance of a retriever component within the context of the entire RAG question answering system.

In the example dataflow of FIG. 2, a query 202 including a question is received by the system (e.g., through an input device 128 of the computing device 110). The query 202 may be received in natural language or another format that may be recognized and processed by the system 200. The query 202 and a set of documents 204 are provided to a retriever 206. Retriever 206 may include or correspond to retriever 120 of computing device 110. All functionality described above with respect to retriever 120 may likewise be applied to or performed by retriever 206.

Retriever 206 may be configured to filter from the set of documents 204, a subset of documents 208, designated as R′. The subset of documents 208 may be selected using dense retrieval methods or another suitable retrieval technique. The subset of documents 208 may be selected based on relevance to the query. Ideally, the filtered subset 208 will contain at least one ground truth document that has a complete and accurate answer to the query 202, in which case the filtered subset may be designated as R, although this is not necessarily guaranteed. A goal of retrieval evaluation is to identify aspects of the retriever 206 that may be modified such that the subset of documents R′ retrieved more closely approaches R. In other words, evaluating the retriever 206 may facilitate improvements to the retrieval component that can more accurately and precisely identify documents that will be most relevant to answering a given query.

The query 204 and the filtered subset of documents 208 may be provided to a first answer generation model 210 to generate an answer 212 to the query based on content of the filtered subset of documents 208. First answer generation model 210 may include or correspond to the question answering model 122 of FIG. 1. Functionality described herein with respect to question answering model 122 may likewise be applied to the first answer generation model 210. For example, the first answer generation model 210 may be implemented as a large language model.

The system 200 may be configured to generate a second answer to the query 202 using a subset of the documents 204. The subset of the documents may include one or more ground truth documents 214 corresponding to the query 202, designated R. The system 200 may provide the query 202 and the one or more ground truth documents 214 to a second answer generation model 216. The second answer generation model 216 may generate a second answer, represented in FIG. 2 as the generated ground truth answer 218. For example, the second answer generation model 216 may generate a second answer 218 using the ground truth documents, establishing—or at least providing a reasonable estimate or baseline of—what answers the system should produce given access to definitively relevant information.

In some implementations, the process of providing the query 202 and the ground truth document(s) 214 to the second answer generation model 216 to generate a ground truth answer 218 may be run in parallel to the process of generating the generated answer 212. Alternatively, the two answer generation processes may be run separately. The timing of the two answer generations is not necessarily critical so long as the first answer 212 is generated without input or influence from the second answer and vice versa. It is the independence and separation of the two answer generation models that provides a measure of confidence that variations or similarities between the answers are the result of performance differences in the retriever 206.

The first answer generation model 210 and the second answer generation model 216 may be configured using the same parameters. In some implementations, the first answer generation model 210 and the second answer generation model 216 may be implemented using the same model, provided that the query and respective subsets of documents are provided to the model separately and independently. In other words, functionality described herein with respect to question answering model 122 may be applied to the second answer generation model 216 in a similar manner as to first answer generation model 210. The second answer generation model 216 may be identical to the first answer generation model 210 in terms of architecture, parameters, and configuration, ensuring that differences between the answers can be attributed primarily to variations in the document subsets rather than model behavior. In some implementations, the system may incorporate safeguards to maintain independence between the two generation processes, such as context resets, separate model instances, or temporal separation between generation tasks.

The second answer 218 represents an approximation of the “ideal” response that the system would generate with perfect retrieval capabilities. While this answer may not be perfectly comprehensive or accurate in all cases, it serves as a useful reference point for evaluating the quality of retrieval, as it reflects what the generation component can produce when provided with documents known to contain relevant information. The format and structure of this answer may vary based on the nature of the query, ranging from short factual statements for simple questions to more elaborate explanations for complex, nuanced, or multifaceted inquiries.

The system 200 may be configured to provide the first answer 212 and the second answer 218 to a comparison model 220. Comparison model 220 may include or correspond to the comparison model 124. Functionality described with respect to comparison model 124 may similarly be achieved with comparison model 220. For example, comparison model 220 may be configured to compare the first answer 212 and the second answer 218 to identify semantic similarities between the first answer and the second answer. Comparison model 220 may be implemented using a large language model. In some configurations, the comparison model 220 may generate an overlap score 222 for the answers. The overlap score 222 may indicate the amount of similarity or dissimilarity between the answers. Such an overlap score may be correlated to the performance of the retriever 206, and may be used to refine or adjust parameters of the retriever 120 to improve information retrieval done by the retriever 120 in future operations of the system 100.

Optionally, the system 200 may be configured to perform a direct comparison between the first answer 212 and a ground truth answer document 230 using a second comparison model 232. The ground truth document 230 may include or correspond to one or more ground truth documents 214. For example, the ground truth document 234 may contain the answer to the question of the query 202 and context related to that answer. The second comparison model 232 may function in a similar manner to the first comparison model 220 but may be configured to operate on a ground truth document and a generated answer instead of operating on two generated answers. The second comparison model may be configured to determine an overlap score 234 indicating a level similarity or dissimilarity between the first answer and the ground truth document 230.

Second overlap score 234 may optionally be provided as feedback to the retriever component 206. In some configurations, the combination of both the first overlap score 222 and the second overlap score 234 may provide for more effective refinement or adjustment of the retriever 206. For example, based on the first overlap score 222 and the second overlap score, parameters of the retriever 206 may be adjusted to cause the retriever 206 to be more effective at retrieving relevant documents from the set of documents 204.

The benefits of system 200 may include more effective information retrieval by a RAG system, as retriever 206 is refined based on the overlap score to identify documents related to a query and disregard documents of less relevance to the query. This can provide not only greater assurance in the quality of documents retrieved but also greater assurance with respect to the retrieved documents' ability to be used in generating answers that are accurate and precise.

Moreover, the system 200 is capable of addressing problems that previous systems for evaluating retrieval components were incapable of handling effectively. For example, prior systems that focused solely on evaluating retrieval components based on comparing answers to annotated documents would not be able to identify correct comparisons from documents that were not annotated as relevant to a particular query. For example, if a document contained the correct answer to the query, but that document had not been annotated, prior systems would not have been able to identify the document and use it to answer the question. This problem occurs when an answer to a question can appear in multiple documents, but only one of them is labeled. This limitation is common in many databases where annotators are unable to search the entire corpus of documents. As a result, traditional metrics may penalize the retriever for not retrieving the gold excerpt (e.g., the ground truth document or portion of a document labeled as a ground truth for a query) from the collection of documents. However, since the answer generation model 210 can generate accurate responses using the documents retrieved, this is not considered a failure, as the correct answer can be reached semantically, even without retrieving the annotated document that the system is aware of.

In a hypothetical situation where the question asked is “where do the greasers live in the outsiders?” a gold excerpt (R) might read: “The story in the book takes place in Tulsa, Oklahoma, in 1965, but this is never explicitly stated in the book.” If a retrieved document (R′) reads: “In Tulsa, Oklahoma, greasers are a gang of tough, low-income working-class teens. They include Ponyboy Curtis and his two older brothers, . . . ” then the system described herein could identify Tulsa, Oklahoma as the correct answer from both the retrieved document and the ground truth document (e.g., the gold excerpt) and provide an overlap score of “yes” or “pass,” even though the retrieved document is not annotated the same as the ground truth document excerpt.

As another example, prior retriever evaluation systems were poorly equipped to handle a retriever returning close but irrelevant chunks of a document alongside the ground truth document(s) for the query. This scenario is more common in LLM-based QA models. In such cases, the retriever receives a high score based on traditional metrics by returning the gold documents. However, the presence of irrelevant chunks alongside the gold documents can lead the LLM to generate incorrect responses. Identifying this possibility allows the system to correct for the influence of such potentially distracting documents.

In another example hypothetical where the question asked is “in which regions are most of Africa's petroleum and natural gas found?” a gold document (R) retrieved may say “Nigeria is the largest oil and gas producer in Africa. Crude oil from the delta basin comes in . . . ” and the gold answer may be “Nigeria, delta basin” with the bolded text as the correct answers. If one of the retrieved documents (R′) reads “The Horn of Africa is a peninsula in Northeast Africa. It juts hundreds of kilometers into . . . ” an LLM answer session may be distracted by the “Horn of Africa” and produce an answer of “Nigeria, Horn of Africa”. In this case, the overlap score may be “no” or “fail” and may indicate that the offending document should be removed from the retrieved documents. In some configurations, the retriever may be penalized for identifying a misleading document to discourage such documents from being retrieved and used to incorrectly answer questions.

Reference is now made to FIG. 3, which illustrates an example dataflow for evaluating information retrieval in a RAG question answering system in accordance with aspects of the present disclosure as dataflow 300. Dataflow 300 illustrates an example of the kind of evaluation that is robust enough to handle discrepancies between the retrieved documents and labelled data. In dataflow 300, the system receives a query 302 asking “who got the first Nobel prize in physics?” The system provides the query 302 to retriever 206, which retrieves retrieved document 308. In this instance, the retrieved document 308 is a newer version of the same Wikipedia page that is the ground-truth (or labeled) document 314, and the updated version has differences from the earlier version.

In a case such as this, traditional metrics operating solely on the retriever would penalize the retriever for not returning the exact same chunk, even though its output is accurate and the generator can answer the question correctly based on context. The answer generation model 310 is able to detect the correct answer of “Wilhelm Conrad Röntgen” in first answer 312 and second answer 318 based on the parts 330 and 334 of the retrieved and labeled documents respectively, even though there are discrepancies between the parts 332 and 336. Those discrepancies might have been material if the question were “how many people have won the Nobel prize in physics?” but that scenario is not described here. As such, since the two answers 312 and 318 match, and the comparison model 320 correctly reports an overlap score 322 of “pass.” Thus, where a conventional metric would have falsely rejected the reviewed text, the systems of the present disclosure are able to keep the document as useful for answering the query.

While LLM-based models for evaluating retrieval components present several advantages over conventional retrieval evaluation techniques, there are a few conditions that can cause LLM-based methods to fail to retrieve documents and identify correct answers to the query that will match with the generated ground truth answers. For example, an LLM answer generation model may be unable to generate a ground truth answer because the LLM may fail to find the correct answer in the text of the ground truth document. This may happen when the information lies within a mal-processed table or text, or the answer to the question is not explicitly mentioned in the text. In such a case, the system may have protocols in place to identify a new ground truth document for the query. Alternatively, such a query may be discarded for use in evaluating the performance of the retrieval component.

As another example, if there are multiple correct answers to the query, it is possible that a ground-truth based LLM may not generate all the correct answers, but instead only generates a subset of the answers. of them. For example the answer to the natural language question “who played Scotty Baldwin's father on general hospital” can be both “Peter Hansen” and “Ross Elliott.” If the ground-truth LLM returns only one of the answers, then the other answer would be considered as incorrect. This issue can be partly addressed by generating ground-truth responses multiple times with a temperature above 0. In this way, the natural variation of the LLM model may account for the several answers. In some implementations, the ground truth model may be configured with instructions to synthesize multiple correct answers into a single answer.

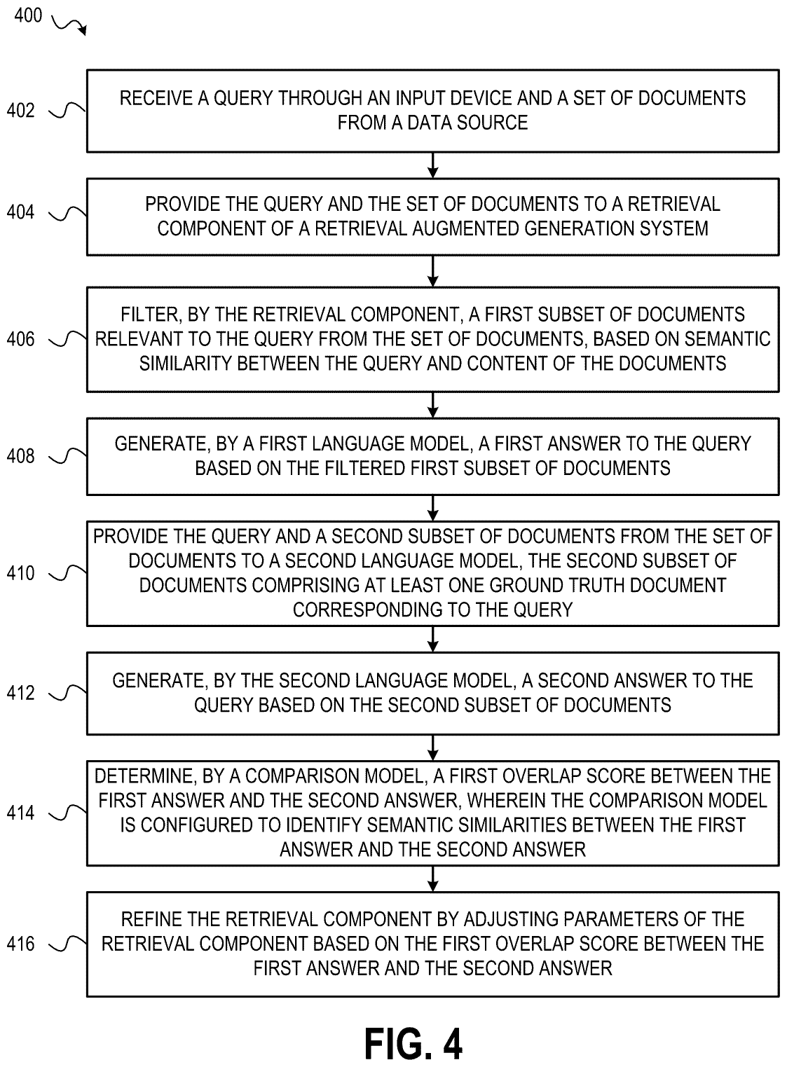

FIG. 4 is a flow diagram of an exemplary method for evaluating and improving a retrieval component in a retrieval augmented generation system in accordance with aspects of the present disclosure, shown as flowchart 400. The method of flowchart 400 may be implemented on a computer system, such as using the memory 114 and the one or more processors 112 of the computing device 110 described herein.

At block 402, the method includes receiving, by one or more processors, a query through an input device and a set of documents from a data source. The query may be a natural language query including a question, and the set of documents may include content that may provide a correct answer to the query. The query may be received through various input mechanisms, such as through a graphical user interface, programmatic API call, or voice recognition system. Queries in this context are typically formulated as natural language questions seeking specific information, though they may also be presented in other formats such as keyword combinations or structured database queries that the system can process. The set of documents from the data source may comprise a diverse collection of text-based materials such as web pages, academic papers, technical documentation, news articles, or specialized domain literature. These documents may be pre-indexed and stored in one or more databases accessible to the system, such as databases 118 shown in FIG. 1, or they may be dynamically accessed from external sources at query time.

At block 404, the method includes providing, by the one or more processors, the query and the set of documents to a retrieval component of a retrieval augmented generation system. The retrieval component may include or correspond to the retriever 120 or the retriever 206 described herein. Here, the retrieval component represents a specialized subsystem designed to efficiently search through large document collections and identify content relevant to the query. This component may implement various information retrieval techniques, ranging from traditional keyword-based approaches to more sophisticated semantic matching methods. In some implementations, the retrieval component may be configured as a modular system that can be replaced or modified independently of other system elements, allowing for flexible adaptation to different retrieval strategies or domain-specific requirements. When providing the query and documents to the retrieval component, the system may also include configuration parameters that influence how the retrieval operation is performed, such as the maximum number of documents to return or specific filtering criteria to apply.

At block 406 the method includes filtering, by the retrieval component, a first subset of documents relevant to the query from the set of documents, based on semantic similarity between the query and content of the documents. The filtered subset of documents may be structured according to techniques disclosed herein.

At block 408 the method includes generating, by a first language model, a first answer to the query based on the filtered first subset of documents. The first language model may be configured as a generative AI system capable of processing both the query and the filtered documents to produce a coherent, contextually appropriate answer. This model may implement various techniques for attending to relevant information within the documents, reasoning about their content in relation to the query, and formulating a response that addresses the question based on available information. The generation process may be guided by specific prompt engineering techniques designed to encourage the model to ground its answer in the provided documents rather than relying on its parametric knowledge.

At block 410 the method includes providing, by the one or more processors, the query and a second subset of documents from the set of documents to a second language model, the second subset of documents comprising at least one ground truth document corresponding to the query. The second subset of documents provided to the second language model differs fundamentally from the first subset in that it contains at least one document known to include information directly relevant to answering the query. These ground truth documents may be identified through various means, such as manual expert annotation, extraction from curated question-answer datasets, or derivation from structured knowledge bases with verified information. By providing the query alongside these documents, the system establishes a controlled condition where the language model has access to definitively relevant information, creating a baseline for comparison with the answer generated using retrieved documents.

At block 412 the method includes generating, by the second language model, a second answer to the query based on the second subset of documents. The second language model generates an answer using the ground truth documents, establishing what the system would produce given access to definitively relevant information. This model may be identical to the first language model in terms of architecture, parameters, and configuration, ensuring that differences between the answers can be attributed primarily to variations in the document subsets rather than model behavior. In some implementations, the system may incorporate safeguards to maintain independence between the two generation processes, such as context resets, separate model instances, or temporal separation between generation tasks.

The second answer represents an approximation of the “ideal” response that the system would generate with perfect retrieval capabilities. While this answer may not be perfectly comprehensive or accurate in all cases, it serves as a useful reference point for evaluating the quality of retrieval, as it reflects what the generation component can produce when provided with documents known to contain relevant information. The format and structure of this answer may vary based on the nature of the query, ranging from short factual statements for simple questions to more elaborate explanations for complex, nuanced, or multifaceted inquiries.

At block 414 the method includes determining, by a comparison model, a first overlap score between the first answer and the second answer, wherein the comparison model is configured to identify semantic similarities between the first answer and the second answer. The comparison model implements specialized logic for assessing similarities between the two generated answers without requiring exact string matching. Rather than focusing on superficial textual similarities, this model evaluates semantic alignment-whether the answers convey the same meaning, contain the same factual claims, or provide equivalent information regardless of specific wording. The comparison may employ various techniques, such as calculating embedding-based similarity metrics, applying natural language inference to detect entailment or contradiction, or leveraging dedicated evaluation models trained on answer comparison tasks.

The first overlap score produced by this comparison represents a quantitative assessment of how closely the answer generated using retrieved documents matches the answer generated using ground truth documents. This score may be expressed in different formats depending on the specific implementation, such as a binary judgment (e.g., “pass” or “fail”), a numerical value on a defined scale, or a multi-dimensional evaluation considering various aspects of answer quality. The comparison model may also generate explanatory output identifying specific areas of agreement or discrepancy between the answers, providing more granular insights into the retrieval component's performance.

At block 416 the method includes refining, by the one or more processors, the retrieval component by adjusting parameters of the retrieval component based on the first overlap score between the first answer and the second answer. The refinement process takes the overlap score as a signal for modifying the retrieval component's operation to improve future performance. This may involve adjusting various parameters that influence how documents are retrieved, such as similarity thresholds, embedding model configurations, token weighting schemes, or document chunking strategies. The specific adjustments may depend on patterns identified in the evaluation results, with different modifications applied for different types of retrieval shortcomings. For instance, if the overlap score indicates that retrieved documents frequently contain misleading information alongside relevant content, the system may adjust parameters to be more selective or implement additional filtering stages. Conversely, if answers generated with retrieved documents consistently lack key information present in ground truth answers, the system may modify parameters to broaden the retrieval scope or adjust ranking algorithms to prioritize different document characteristics.

In some implementations, this refinement may be performed through automated optimization techniques that systematically explore the parameter space to identify configurations maximizing overlap scores across multiple queries. This creates a feedback loop where retrieval performance continuously improves based on end-to-end evaluation rather than isolated component metrics. The refinement process may also incorporate domain-specific considerations for specialized applications, such as adjusting parameters differently for legal, medical, or technical queries that may have distinct retrieval requirements.

The methods described in FIG. 4 are illustrative of the kind of operations that a system such as has been described herein may be configured to perform. Those of ordinary skill in the art would recognize that variations and modifications may be made to the methods, systems, and computer readable media disclosed herein without departing from the scope of this disclosure. For example, in some implementations, the method may further include determining, by the one or more processors, a recall metric and a precision metric for the first subset of documents filtered by the retrieval component based on the query; and providing the recall metric and the precision metric to the comparison model as input parameters for determining the overlap between the first answer and the second answer. Recall and precision metrics are conventional metrics for evaluating the performance of a retrieval component, and while these conventional metrics may not be as effective at improving information retrieval on their own, in combination with an LLM-model for evaluating the retrieval component as has been described herein, these metrics may provide additional insights into parameters of the retrieval component that may be modified to improve retrieval.

In some implementations, the method may further include determining a second overlap score between the ground truth document and the first answer using a second comparison model, the second comparison model configured to identify semantic similarities between the first answer and the ground truth document; and refining, by the one or more processors, the retrieval component by adjusting the parameters of the retrieval component based on the second overlap score. In this manner, the method may combine the evaluation techniques and tools of the present disclosure that provide a measure of the retrieval component in context of the RAG system as a whole with previous techniques of evaluating the retrieval component in isolation. While the isolated evaluation techniques-including methods of measuring recall, precision, and F-score metrics for the retrieval component-on their own may be insufficient for evaluating the retrieval component's performance in connection with the answer generation model, by considering both the metrics of the retrieval component's performance on its own as well as in the system as a whole, a more comprehensive or nuanced refinement of the retrieval component can be achieved.

In some such implementations, the method may include identifying, by the one or more processors, a failure state of the retrieval component based on comparing the first overlap score and the second overlap score. For example, the failure state may include a failure to identify a relevant document with the correct answer to the query, a rejection of a document that does contain a correct answer, or the inclusion of a document that is related to the topic of the query, but also provides misleading or irrelevant information t the query. Other failure states may also be apparent from comparing the first overlap score and second overlap scores.

In some implementations, the method may include generating, by the second language model, a set of answers in addition to the second answer by providing the second subset of documents to the second language model multiple times using a temperature parameter greater than zero.

In some implementations, the method may include identifying, by the one or more processors, a misleading document in the first subset of documents retrieved by the retrieval component based on the first overlap score, wherein the misleading document is semantically dissimilar from the at least one ground truth document; and refining the retrieval component by adjusting the parameters of the retrieval component to penalize the retrieval component for including the misleading document.

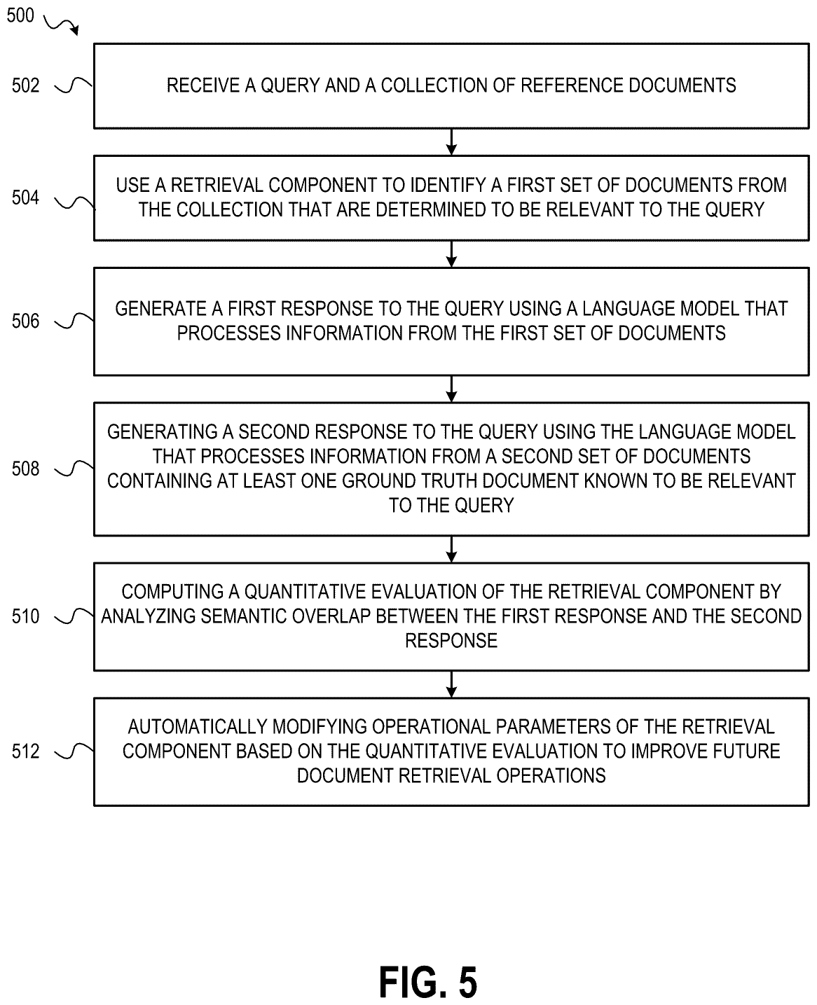

FIG. 5 is a flow diagram of an exemplary method for evaluating and improving information retrieval in a question-answering system in accordance with aspects of the present disclosure, shown as flowchart 500.

At block 502, the method may include receiving, by one or more processors, a query and a collection of reference documents. The query may be received through various input devices, such as a keyboard, touchscreen, or microphone, and may be formulated as a natural language question. The collection of reference documents may be obtained from one or more data sources, databases, or document repositories, such as those illustrated in FIG. 1 (e.g., data source 140). These reference documents may include various types of content, such as web pages, scholarly articles, legal documents, technical documentation, or other text-based materials containing information potentially relevant to answering the query.

At block 504, the method includes using a retrieval component to identify a first set of documents from the collection that are determined to be relevant to the query. The retrieval component may employ various techniques to identify relevant documents, including dense retrieval methods that operate in an embeddings space. For example, the retrieval component may encode both the query and the documents using an embeddings model, then calculate similarity scores (such as cosine similarity) between the query embeddings and document embeddings. Documents with similarity scores exceeding a predetermined threshold or ranking among the top N scores may be selected for inclusion in the first set. This retrieval process represents a foundational element of the method, as the quality of retrieved documents directly influences the accuracy of the generated response.

At block 506 the method includes generating a first response to the query using a language model that processes information from the first set of documents. The language model used in block 506 may be configured as a large language model (LLM) trained to process natural language input and generate coherent, contextually appropriate responses. The language model may receive both the query and the first set of documents as input, potentially formatted with a specific prompt structure designed to elicit an answer based on the provided documents. The generated first response represents the system's attempt to answer the query using only the information identified by the retrieval component, without access to known ground truth documents.

At block 508 the method includes generating a second response to the query using the language model that processes information from a second set of documents containing at least one ground truth document known to be relevant to the query. The second set of documents differs from the first set primarily through the guaranteed inclusion of at least one ground truth document. Ground truth documents may be identified through various means, such as manual annotation by subject matter experts, derivation from question-answer pairs in training datasets, or extraction from curated knowledge bases. The language model used to generate the second response may be identical to the model used in block 506, including the same parameters, configuration, and prompt structure. This consistency ensures that any differences between the first and second responses can be attributed primarily to differences in the document sets rather than variations in model behavior.

In some implementations, the language model may generate the second response in parallel with the first response to minimize potential interference between the two generation processes. Alternatively, the system may implement safeguards such as context resets between generation tasks to maintain independence between the responses. The objective is to create a controlled comparison where the only significant variable is the difference between the retrieved documents and the ground truth documents.

At block 510 the method includes computing a quantitative evaluation of the retrieval component by analyzing semantic overlap between the first response and the second response. Block 510 may employ various comparison techniques depending on the specific requirements of the system. For queries with straightforward factual answers, a binary evaluation (e.g., “pass” or “fail”) may be sufficient to determine whether the retrieved documents enabled the generation of a correct response. For more complex queries or specialized domains requiring nuanced answers, the system may implement more granular evaluation metrics that consider partial matches, contextual relevance, or domain-specific criteria. The comparison may be performed by a dedicated comparison model, which may itself be implemented as a language model trained specifically for evaluation tasks.

The automatic modification of operational parameters in block 512 represents a key advancement over manual tuning approaches. Based on the quantitative evaluation, the system may adjust various aspects of the retrieval component, such as similarity thresholds, embedding model configurations, document chunking strategies, or ranking algorithms. These adjustments may be implemented through various optimization techniques, including gradient-based methods, reinforcement learning approaches, or rule-based systems that respond to specific patterns identified in the evaluation results. The ultimate goal is to create a feedback loop that progressively improves retrieval performance based on end-to-end system evaluation rather than isolated component metrics.

At block 512 the method includes automatically modifying operational parameters of the retrieval component based on the quantitative evaluation to improve future document retrieval operations. Block 512 represents an advancement over manual tuning approaches. Based on the quantitative evaluation, the system may adjust various aspects of the retrieval component, such as similarity thresholds, embedding model configurations, document chunking strategies, or ranking algorithms. For the modification process in block 512, the system may implement various optimization techniques to refine retrieval parameters. These may include adjustments to the semantic similarity thresholds used when comparing query and document embeddings, modifications to the weighting schemes applied to different sections or elements within documents, or changes to the number of documents retrieved for each query. The system may also adjust parameters related to document preprocessing, such as the chunking strategy used to divide documents into manageable segments or the filtering mechanisms used to remove potentially irrelevant content.

In some implementations, the parameter modification may employ machine learning approaches, where the system learns from successful and unsuccessful retrieval outcomes to gradually improve performance over time. This could involve reinforcement learning techniques that reward parameter configurations leading to high semantic overlap between responses generated with retrieved documents and those generated with ground truth documents. Alternatively, the system might implement more direct optimization methods that systematically explore the parameter space to identify configurations maximizing retrieval effectiveness within the context of the entire question-answering pipeline.

The feedback loop created by this automatic modification process enables continuous improvement of the retrieval component based on real-world performance rather than isolated metrics. This approach may be particularly valuable for adapting retrieval systems to specific domains or use cases, where general-purpose retrieval parameters might not yield optimal results.

The methods described in FIG. 5 are illustrative of the kind of operations that a system such as has been described herein may be configured to perform. Those of ordinary skill in the art would recognize that variations and modifications may be made to the methods, systems, and computer readable media disclosed herein without departing from the scope of this disclosure.

Those of skill in the art would appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

Functional blocks and modules in FIGS. 1-5 may include processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is, one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

Although the present invention and its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A computer-implemented method for evaluating and improving a retrieval component in a retrieval augmented generation system, comprising:
receiving, by one or more processors, a query through an input device and a set of documents from a data source;
providing, by the one or more processors, the query and the set of documents to a retrieval component of a retrieval augmented generation system;
filtering, by the retrieval component, a first subset of documents relevant to the query from the set of documents, based on semantic similarity between the query and content of the documents;
generating, by a first language model, a first answer to the query based on the filtered first subset of documents;
providing, by the one or more processors, the query and a second subset of documents from the set of documents to a second language model, the second subset of documents comprising at least one ground truth document corresponding to the query;
generating, by the second language model, a second answer to the query based on the second subset of documents;
determining, by a comparison model, a first overlap score between the first answer and the second answer, wherein the comparison model is configured to identify semantic similarities between the first answer and the second answer; and
refining, by the one or more processors, the retrieval component by adjusting parameters of the retrieval component based on the first overlap score between the first answer and the second answer.

2. The computer-implemented method of claim 1, further comprising:
determining, by the one or more processors, a recall metric and a precision metric for the first subset of documents filtered by the retrieval component based on the query; and
providing the recall metric and the precision metric to the comparison model as input parameters for determining the overlap between the first answer and the second answer.

3. The computer-implemented method of claim 1, further comprising:
determining a second overlap score between the ground truth document and the first answer using a second comparison model, the second comparison model configured to identify semantic similarities between the first answer and the ground truth document; and
refining, by the one or more processors, the retrieval component by adjusting the parameters of the retrieval component based on the second overlap score.

4. The computer-implemented method of claim 3, further comprising identifying, by the one or more processors, a failure state of the retrieval component based on comparing the first overlap score and the second overlap score.

5. The computer-implemented method of claim 1, further comprising generating, by the second language model, a set of answers in addition to the second answer by providing the second subset of documents to the second language model multiple times using a temperature parameter greater than zero.

6. The computer-implemented method of claim 1, further comprising:
identifying, by the one or more processors, a misleading document in the first subset of documents retrieved by the retrieval component based on the first overlap score, wherein the misleading document is semantically dissimilar from the at least one ground truth document; and
refining the retrieval component by adjusting the parameters of the retrieval component to penalize the retrieval component for including the misleading document.

7. A system for processing a fact pattern to identify applicable legal claims, the system comprising:
a memory; and
one or more processors communicatively coupled to the memory, the one or more processors configured to:
receive a query through an input device and a set of documents from a data source;
provide the query and the set of documents to a retrieval component of a retrieval augmented generation system;
filter, by the retrieval component, a first subset of documents relevant to the query from the set of documents, based on semantic similarity between the query and content of the documents;
generate, by a first language model, a first answer to the query based on the filtered first subset of documents;
provide the query and a second subset of documents from the set of documents to a second language model, the second subset of documents comprising at least one ground truth document corresponding to the query;
generate, by the second language model, a second answer to the query based on the second subset of documents;
determine, by a comparison model, a first overlap score between the first answer and the second answer, wherein the comparison model is configured to identify semantic similarities between the first answer and the second answer; and
refine the retrieval component by adjusting parameters of the retrieval component based on the first overlap score between the first answer and the second answer.

8. The system of claim 7, wherein the one or more processors are further configured to:
determine a recall metric and a precision metric for the first subset of documents filtered by the retrieval component based on the query; and
provide the recall metric and the precision metric to the comparison model as input parameters for determining the overlap between the first answer and the second answer.

9. The system of claim 7, wherein the one or more processors are further configured to:
determine a second overlap score between the ground truth document and the first answer using a second comparison model, the second comparison model configured to identify semantic similarities between the first answer and the ground truth document; and
refine the retrieval component by adjusting the parameters of the retrieval component based on the second overlap score.

10. The system of claim 9, wherein the one or more processors are further configured to identify a failure state of the retrieval component based on comparing the first overlap score and the second overlap score.

11. The system of claim 7, wherein the one or more processors are further configured to generate, by the second language model, a set of answers in addition to the second answer by providing the second subset of documents to the second language model multiple times using a temperature parameter greater than zero.

12. The system of claim 7, wherein the one or more processors are further configured to:
identify a misleading document in the first subset of documents retrieved by the retrieval component based on the first overlap score, wherein the misleading document is semantically dissimilar from the at least one ground truth document; and
refine the retrieval component by adjusting the parameters of the retrieval component to penalize the retrieval component for including the misleading document.

13. A computer-implemented method for evaluating and improving information retrieval in a question-answering system, comprising:
receiving, by one or more processors, a query and a collection of reference documents;
using a retrieval component to identify a first set of documents from the collection that are determined to be relevant to the query;
generating a first response to the query using a language model that processes information from the first set of documents;
generating a second response to the query using the language model that processes information from a second set of documents containing at least one ground truth document known to be relevant to the query;
computing a quantitative evaluation of the retrieval component by analyzing semantic overlap between the first response and the second response; and
automatically modifying operational parameters of the retrieval component based on the quantitative evaluation to improve future document retrieval operations.

14. The computer-implemented method of claim 13, further comprising:
encoding, by the retrieval component, both the query and the first set of documents using an embeddings model to generate a set of query embeddings and a set of document embeddings; and
calculating, by the retrieval component, a similarity score between the set of query embeddings and the set of document embeddings.

15. The computer-implemented method of claim 13, wherein the language model is a large language model (LLM) trained to process natural language input and generate a coherent, contextually appropriate response to the query.

16. The computer-implemented method of claim 13, wherein generating the second response is performed in parallel with generating the first response to minimize potential interference between the two generation processes.

17. The computer-implemented method of claim 13, further comprising generating, by the language model, a set of responses in addition to the second response by providing the second set of documents to the language model multiple times using a temperature parameter greater than zero.

18. The computer-implemented method of claim 13, further comprising:
identifying, by the language model, a misleading document in the first set of documents identified by the retrieval component, wherein the misleading document is semantically dissimilar from the at least one ground truth document based on the quantitative evaluation; and
automatically modifying the operational parameters of the retrieval component to penalize the retrieval component for including the misleading document.

19. The computer-implemented method of claim 13, wherein automatically modifying operational parameters of the retrieval component comprises automatically modifying one or more of a similarity threshold, an embedding model configuration, a document chunking strategy, a ranking algorithm, a prompt provided to the retrieval component, or a combination thereof.

20. The computer-implemented method of claim 13, wherein the ground truth document is identified based on a manual annotation by s subject matter expert, derived from one or more question-answer pairs in training datasets, extracted from one or more curated knowledge bases, or a combination thereof.
